(19) United States
(12) Patent Application Publication
(10) Pub. No.: US 2012/0293979 A1
(43) Pub. Date: Nov. 22, 2012

(54) BACKLIGHT MODULE AND DISPLAY APPARATUS

(75) Inventor: Yanxue Zhang, Shenzhen (CN)

(73) Assignee: Shenzhen China Star Optoelectronics Technology Co. Ltd., Shenzhen (CN)

(21) Appl. No.: 13/147,684

(22) PCT Filed: May 27, 2011
(86) PCT No.: PCT/CN11/74800

§ 371 Date: Aug. 3, 2011

(30) Foreign Application Priority Data
May 16, 2011 (CN) 201120155839.4

(51) Int. Cl. F21V 9/16; G09F 13/04

(52) U.S. Cl. 362/84; 362/97.1

(57) ABSTRACT

The present invention provides a backlight module and a display apparatus. The backlight module comprises a circuit board; a plurality of light sources disposed on the circuit board; and a lens sheet disposed on the circuit board, wherein the lens sheet includes a plurality of recesses, and the light sources are received in the recesses. The invention can omit a light guide plate or optical films.

### FIELD OF THE INVENTION

The present invention relates to a backlight module and a display apparatus, and more particularly to a direct-light type backlight module and a display apparatus using the same.

### BACKGROUND OF THE INVENTION

Liquid crystal displays (LCDs) have been widely applied in electrical products. Currently, most of LCDs are backlight type LCDs which comprise a liquid crystal panel and a backlight module. According to the position of the backlight source, the backlight module can be a side-light type or a direct-light type in order to provide the liquid crystal panel with backlight. Taking the direct-light type backlight module for example, it uses lamps or light bars to be light sources for providing the liquid crystal panel with backlight.

However, a light guide plate or a diffuser is required for the light of the light sources of the side-light type or direct-light type backlight module to form a plane light source, thus increasing weight and assembly steps of the backlight module.

As a result, it is necessary to provide a backlight module and a display apparatus to solve the problems existing in the conventional technologies, as described above.

### SUMMARY OF THE INVENTION

The invention provides a backlight module and a display apparatus to solve the light guide problem of the backlight module

A primary object of the present invention is to provide a backlight module, and the backlight module comprises: a circuit board; a plurality of light sources disposed on the circuit board; and a lens sheet disposed on the circuit board, wherein the lens sheet includes a plurality of recesses, and the light sources are received in the recesses.

Another object of the present invention is to provide a backlight module, and the backlight module comprises: a circuit board; a plurality of light emitting diode chips disposed on the circuit board; a lens sheet disposed on the circuit board, wherein the lens sheet includes a plurality of recesses, and the light emitting diode chips are received in the recesses; and a phosphor layer formed on inner surfaces of the recesses.

A further object of the present invention is to provide a display apparatus, which comprises a display panel and a backlight module. The backlight module comprises a circuit board; a plurality of light sources disposed on the circuit board; and a lens sheet disposed on the circuit board, wherein the lens sheet includes a plurality of recesses, and the light sources are received in the recesses.

In one embodiment of the present invention, the lens sheet further includes a phosphor layer formed on inner surfaces of the recesses.

In one embodiment of the present invention, the cross-sectional shapes of the recesses are trapezoids or semicircles.

In one embodiment of the present invention, the light sources are a plurality of light emitting diode chips.

In one embodiment of the present invention, a light output surface of the lens sheet includes a plurality of protruding structures.

In one embodiment of the present invention, a light output surface of the lens sheet includes a cloudy surface or a plurality of scattering patterns.

In one embodiment of the present invention, the backlight module further comprises a reflective layer disposed on the circuit board and between the light sources.

The backlight module and the display apparatus of the present invention can use the lens sheet to uniform the light of the light sources for forming a uniform plane light source, thus omitting the convention light guide plate or optical film. Therefore, with use of the backlight module and the display apparatus of the present invention, the weight thereof can be reduced, and the assembly steps thereof can be simplified.

The structure and the technical means adopted by the present invention to achieve the above and other objects can be best understood by referring to the following detailed description of the preferred embodiments and the accompanying drawings.

### DESCRIPTION OF THE DRAWINGS

FIG. 1 is a cross-sectional view showing a backlight module and a display panel according to a first embodiment of the present invention;

FIG. 2 is a bottom view showing the lens sheet to the first embodiment of the present invention; and

FIG. 3 is a partially cross-sectional view showing a lens sheet according to a second embodiment of the present invention.

### DETAILED DESCRIPTION OF THE PREFERRED EMBODIMENTS

The following embodiments are referring to the accompanying drawings for exemplifying specific implementable embodiments of the present invention. Furthermore, directional terms described by the present invention, such as upper, lower, front, back, left, right, inner, outer, side and etc., are only directions by referring to the accompanying drawings, and thus the used directional terms are used to describe and understand the present invention, but the present invention is not limited thereto.

In the drawings, structure-like elements are labeled with like reference numerals.

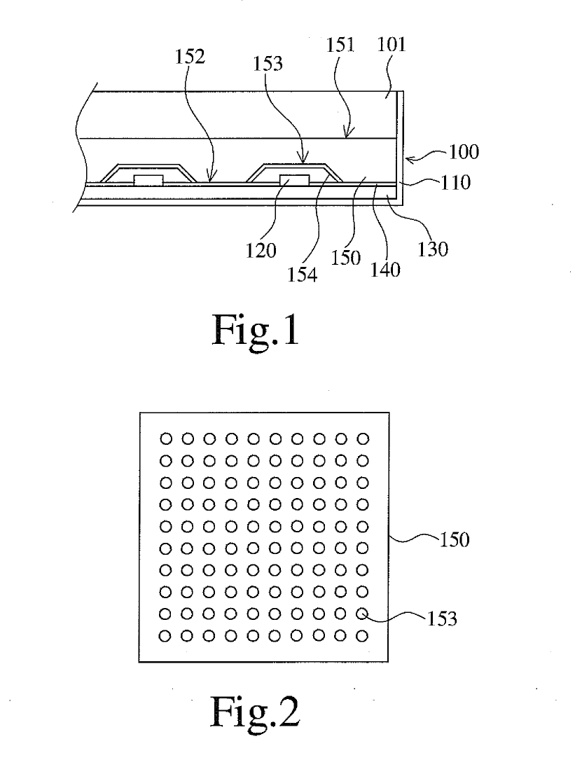

Referring to FIG. 1, a cross-sectional view showing a backlight module and a display panel according to a first embodiment of the present invention is illustrated. The backlight module 100 of the present embodiment may be a direct-light type backlight module disposed opposite to a display panel 101, thereby forming a display apparatus (such an LCD apparatus). The display panel 101 may be a liquid crystal display panel. The backlight module 100 may comprises a back bezel 110, a plurality of light sources 120, a circuit board 130, a reflective layer 140 and a lens sheet 150.

Referring to FIG. 1 again, the back bezel 110 of the present embodiment may be made of an opaque material, such as plastic, metal or any combination material thereof for carrying the light sources 120, the circuit board 130 and the lens sheet 150. The light sources 120 are disposed on the circuit board 130 and electrically connected to the circuit board 130 for providing light to the display panel 101. The fight sources 120 are preferably point light sources, such as light emitting diodes (LEDs), organic light emitting diodes (OLEDs) or electro-luminescence (ELs) devices. In this embodiment, the light sources 120 may be LED chips which are arranged on the circuit board 130, and there is a predetermined interval between each two adjacent light sources 120.

Referring to FIG. 1 again, the circuit board 130 is disposed on the back bezel 110 and electrically connected to light sources 120 for controlling the lighting of the light sources 120. The circuit board 130 may be a printed circuit board (PCB) or a flexible printed circuit (FPC).

Referring to FIG. 1 again, the reflective layer 140 can be disposed on the circuit board 130 and formed between or around the light sources 120. The reflective layer 140 of the present embodiment may be a reflective plate or a reflective sheet for reflecting light. The reflective layer 140 may be made of a highly reflective material, such as Ag, Al, Au, Cr, Cu, In, Ir, Ni, Pt, Re, Rh, Sn, Ta, W, Mn, any alloy combination thereof, white reflective paint with etiolation-resistant and heat-resistant properties or any combination thereof.

Referring to FIG. 1 and FIG. 2, FIG. 2 is a bottom view showing the lens sheet to the first embodiment of the present invention. The lens sheet 150 may be made as one-piece by using injection molding, extrusion molding, stamping, cutting, casting, machining, compression molding or forging. The material of the lens sheet 150 may be photo-curable resin, polymethylmethacrylate (PMMA) or polycarbonate (PC). The lens sheet 150 includes a light output surface 151, a bottom surface 152, a plurality of recesses 153 and a phosphor layer 154. The light output surface 151 is formed at one side of the lens sheet 150 and faces to the liquid crystal display panel 101 for allowing the light of the light sources 120 to be outputted thereto. The bottom surface 152 is formed at another side of the lens sheet 150 and faces to the circuit board 130. The recesses 153 are formed on the bottom surface 152 for receiving and packaging the light sources 120, and each of the recesses 153 can act as a concave lens for diffusing the light of the light sources 120. The light of the light sources 120 can be diffused and uniformed by the recesses 153 of the lens sheet 150 for mixing light, so as to provide a uniform plane light source to the liquid crystal display panel 101. The phosphor layer 154 is formed on an inner surface of each of the recesses 153 and excited by the light of the light sources 120 to emit visible light. Therefore, the luminous efficiency or light color of the light sources 120 can be improved by using the phosphor layer 154.

In this embodiment, an opening width of each of the recesses 153 is at least larger than a width of each of the light sources 120, so as to receive the light sources 120 in the recesses 153 of the lens sheet 150. According to an optical design of the lens sheet 150, cross-sectional shapes of the recesses 153 may be trapezoids, semicircles or any other shapes. Furthermore, according to a user's a practical requirement, the shape or size of the recesses 153 can be adjustable for forming an optimum and uniform surface-light source.

When assembling the display apparatus of the present embodiment, firstly, the circuit board 130 with the light sources 120 arranged thereon is disposed on the back bezel 110. Subsequently, the lens sheet 150 can be disposed on the circuit board 130. At this time, the light sources 120 are correspondingly received and packaged in the recesses 153 of the lens sheet 150. Subsequently, the display panel 101 is disposed above the lens sheet 150, so as to achieve the display apparatus.

Therefore, with use of the lens sheet 150 of the present embodiment, the light of the light sources 120 of the backlight module 100 can be uniformed for forming a uniform plane light source, thus omitting the conventional light guide plate or optical film. Since the light guide plate or optical film can be omitted, the weight of the backlight module 100 of the present embodiment can be reduced, and the assembly steps can be simplified. Moreover, the light of the light sources 120 is pre-mixed by the concave lens of the lens sheet 150, thereby reducing the required light mixing space and a thickness of the backlight module 100.

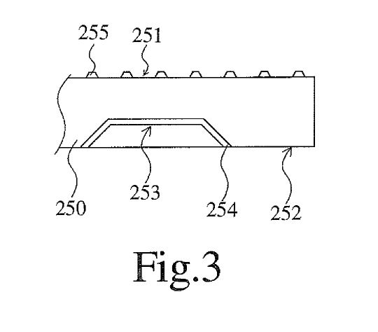

Referring to FIG. 3, a partially cross-sectional view showing a lens sheet according to a second embodiment of the present invention is illustrated. Only the difference between the embodiment and the first embodiment are described hereinafter, and the similar construction therebetween is not stated in detail herein. In comparison with the first embodiment, the lens sheet 250 of the backlight module of the second embodiment comprises a light output surface 251, a bottom surface 252, a plurality of recesses 253 and a phosphor layer 254. The light output surface 251 and the bottom surface 252 are positioned at two opposite sides of the lens sheet 250. The recesses 253 are formed on the bottom surface 252 for receiving and packaging the light sources 120. The phosphor layer 254 is formed on the inner surface of each of the recesses 253 and excited by the light of the light sources 120 to emit visible light. The light output surface 251 of the lens sheet 250 of the second embodiment may include a plurality of protruding structures 255 to modify the direction of light, thereby condensing light and enhancing the brightness thereof, wherein the protruding structures 255 may be prism-shaped structures or semicircular structures. Furthermore, the light output surface 251 may include a cloudy surface or a plurality of scattering patterns to uniform the light outputted from the light sources 120, i.e. the situation of mura is prevented.

As described above, the backlight module and the display apparatus of the present invention can use the lens sheet to uniform the light of the light sources for forming a uniform plane light source. Therefore, with use of the backlight module of the present invention, the convention light guide plate or optical film can be omitted, so as to reduce the weight thereof and simplify the assembly steps of the backlight module.

The present invention has been described with a preferred embodiment thereof and it is understood that many changes and modifications to the described embodiment can be carried out without departing from the scope and the spirit of the invention that is intended to be limited only by the appended claims.

1. A backlight module, comprising:
a circuit board;
a plurality of light emitting diode chips disposed on the circuit board;
a lens sheet disposed on the circuit board, wherein the lens sheet includes a plurality of recesses, and the light emitting diode chips are received in the recesses; and
a phosphor layer formed on inner surfaces of the recesses.

2. A backlight module, comprising:
a circuit board;
a plurality of light sources disposed on the circuit board; and
a lens sheet disposed on the circuit board, wherein the lens sheet includes a plurality of recesses, and the light sources are received in the recesses.

3. The backlight module according to claim 2, wherein the lens sheet further includes a phosphor layer formed on inner surfaces of the recesses.

4. The backlight module according to claim 2, wherein the cross-sectional shapes of the recesses are trapezoids or semicircles.

5. The backlight module according to claim 2, wherein the light sources are a plurality of light emitting diode chips.

6. The backlight module according to claim 2, wherein a light output surface of the lens sheet includes a plurality of protruding structures.

7. The backlight module according to claim 2, wherein a light output surface of the lens sheet includes a cloudy surface or a plurality of scattering patterns.

8. The backlight module according to claim 2, further comprising a reflective layer disposed on the circuit board and between the light sources.

9. A display apparatus, comprising:
a display panel; and
a backlight module comprising:
a circuit board;
a plurality of light sources disposed on the circuit board; and
a lens sheet disposed on the circuit board, wherein the lens sheet includes a plurality of recesses, and the light sources are received in the recesses.

10. The display apparatus according to claim 9, wherein the lens sheet further includes a phosphor layer formed on inner surfaces of the recesses.

11. The display apparatus according to claim 9, wherein the cross-sectional shapes of the recesses are trapezoids or semicircles.

12. The display apparatus according to claim 9, wherein the light sources are a plurality of light emitting diode chips.

13. The display apparatus according to claim 9, wherein a light output surface of the lens sheet includes a plurality of protruding structures.

14. The display apparatus according to claim 9, wherein a light output surface of the lens sheet includes a cloudy surface or a plurality of scattering patterns.

15. The display apparatus according to claim 9, further comprising a reflective layer disposed on the circuit board and between the light sources.
